(19) United States
(12) Patent Application Publication
(10) Pub. No.: US 2018/0239838 A1
(43) Pub. Date: Aug. 23, 2018

(54) DISPLAY PROCESSING APPARATUS AND DISPLAY PROCESSING METHOD

(71) Applicant: NEC CORPORATION, Tokyo (JP)

(72) Inventor: Jianquan LIU, Tokyo (JP)

(73) Assignee: NEC CORPORATION, Tokyo (JP)

(21) Appl. No.: 15/751,668

(22) PCT Filed: Jun. 17, 2016
(86) PCT No.: PCT/JP2016/068054

§ 371 Date: Feb. 9, 2018

(30) Foreign Application Priority Data
Aug. 10, 2015 (JP) 2015-158366

(51) Int. Cl. G06F 17/30

(52) U.S. Cl. CPC G06F 17/30991; G06F 17/30061; G06F 17/30327; G06F 17/30994; G06F 17/30256

(57) ABSTRACT

A display processing apparatus includes an acquisition unit (101) and an output processing unit (102). The acquisition unit (101) acquires, for each of a plurality of pieces of similarity data extracted by similarity search based on query data, a similarity degree value indicating a similarity with the query data. The output processing unit (102) outputs a display including a region indicating the query data positioned at one end and a plurality of regions indicating respective ones of the plurality of pieces of similarity data positioned at respective positions corresponding to the respective similarity degree values of the respective pieces of similarity data on a line extending from the one end in a predetermined shape.

### TECHNICAL FIELD

The present invention relates to a technology of displaying a result obtained by similarity search.

### BACKGROUND ART

Currently, various information visualization technologies are being proposed. For example, information visualization technology relating to clustering is classified into three categories: a cluster visualization technology; a graph visualization technology for drawing a network graph; and a search engine technology for visualizing a search result.

For the cluster visualization technology, tools as follows are provided. “The R Project for Statistical Computing” provides open source free software which is called “R”. “R” is a programming language for statistical analysis and computing, an environment for developing and executing the programming language, and a graph drawing tool. “R” implements clustering methods such as K-Means and density-based spatial clustering (DBSCAN) and provides a function of visualizing clustering results of the methods. “Data-Driven Documents” provides a JavaScript (registered trademark) library called “D3.js”. “D3.js” is a data visualization tool based on W3C for dynamically drawing contents on web browsers. “D3.js” provides a function of drawing clusters having a preset inclusion relation with each other on browsers by using a module such as “Zoomable Circle Packing”. “ManyEyes”, a tool for data analysis and visualization, achieves visualization of cluster data by plotting bubbles having numeric or text data on the surfaces thereof. Further, there is a tool called “jqPlot” which is a plug-in of jQuery that operates on a framework of Javascript (registered trademark) and is configured to generate a graph (chart, diagram). “jqPlot” visualizes cluster data by plotting bubbles on a two-dimensional coordinate plane.

For the technology of visualizing graph data centering on networks, tools as follows are provided. For example, open source software called “Cytoscape” integrates, analyzes, and visualizes pieces of network data in one box. Open source software called “Gephi” manipulates network data (see the following Non-Patent Document 1). “CuttleFish” which is a flexible workbench was developed in order to perform research on networks. A graph processing tool called “GraphChi” was developed in order to allow large-scale graph computation on only one personal computer (PC) (see the following Non-Patent Document 2). A framework called “JUNG” written in Java (registered trademark) is configured to draw universal networks and graphs. Further, a tool called “NodeXL” is also provided. “NodeXL” is a drawing template developed in order to summarize, find, and search for networks for Microsoft Excel.

Search engines are provide for implementing visualization of search results based on a web document or a text document. For example, “Vivisimo Velocity” is a search engine that dynamically displays search results, that is, it classifies web documents in advance based on a keyword used in web search and hierarchically displays clusters obtained in accordance with the classification. Non-Patent Document 3 below refers to a technology of clustering a web document in advance and hierarchically creating circles for clusters with keywords to dynamically display search results. In addition, in known search engines, search results are also displayed in an order based on the ranking of each of the search results.

Meanwhile, as described in Patent Documents 1 and 2 below, currently, various similarity search methods are being proposed. Multi-dimensional data or high-dimensional data such as feature value data of an image are often searched using such a similarity search method. For example, Patent Documents 1 and 2 propose general-purpose similarity search based on a hierarchical relation of similarity without depending on data structures of data to be searched or on similarity calculation methods.

Patent Document 3 below discloses creating a plurality of search queries related to a search request of a user, calculating similarity between the search query and data in a database, and displaying a list of search results for each search query on the same screen. Patent Document 3 discloses selecting one or a plurality of search results in order from those having a high similarity with the search query, clustering feature values of a set of search results, determining one or a plurality of classes having large clusters, and selecting and displaying a cluster present at the center thereof. Patent Document 4 below discloses displaying a plurality of images corresponding to a plurality of search results having a degree of coincidence with a search condition of equal to or greater than a predetermined value in respective sizes and respective positions depending on the degree of coincidence with the search condition, thus allowing to intuitively recognize the degree of matching of each search result with the search condition.

### RELATED DOCUMENT

### Patent Document

[Patent Document 1] Japanese Patent Application Publication No. 2015-49574
[Patent Document 2] International Publication No. WO 2014/109127
[Patent Document 3] Japanese Patent Application Publication No. 2007-323319
[Patent Document 4] Japanese Patent Application Publication No. 2000-222416

### Non-Patent Document

[Non-Patent Document 1] Bastian M., Heymann S., Jacomy M., “Gephi: An Open Source Software for Exploring and Manipulating Networks”, Third International AAAI Conference on Weblogs and Social Media, 2009.
[Non-Patent Document 2] Aapo Kyrola, Guy E. Blelloch, Carlos Guestrin, “GraphChi: Large-Scale Graph Computation on Just a PC”, OSDI 2012, 31-46
[Non-Patent Document 3] John Markoff, “Your Internet Search Results, in the Round”, The New York Times, Published 2005 May 9.

### SUMMARY OF THE INVENTION

### Technical Problem

However, the above methods merely express relationships or differentiation between pieces of data and do not quantitatively express the degree of similarity between the pieces of data. For example, the methods merely express each piece of data distinguishably by the size or color of a circle or express the relationship between pieces of data using edges between nodes on a graph. The method in Patent Document 4 displays a plurality of images corresponding to search results in sizes and at positions in accordance with the degrees of coincidence with the search condition. However, this method of expression has room for improvement in view of ease of recognition.

Considering such circumstances, the present invention provides a technology of expressing similarity search results allowing easy and intuitive recognition of the results.

### Solution to Problem

To solve the above-described problem, aspects of the present invention employ the respective configurations described below.

A first aspect relates to a display processing apparatus. The display processing apparatus according to the first aspect includes an acquisition unit configured to acquire, for each of a plurality of pieces of similarity data extracted by similarity search based on query data, a similarity degree value indicating a similarity with the query data; and an output processing unit configured to output a display including a region indicating the query data positioned at one end and a plurality of regions indicating respective ones of the plurality of pieces of similarity data positioned at respective positions corresponding to the respective similarity degree values of the respective pieces of similarity data, on a line extending from the one end in a predetermined shape.

A second aspect relates to a display processing method performed by at least one computer. The display processing method according to the second aspect includes: acquiring, for each of a plurality of pieces of similarity data extracted by similarity search based on query data, a similarity degree value indicating a similarity with the query data; and outputting a display including a region indicating the query data positioned at one end and a plurality of regions indicating respective ones of the plurality of pieces of similarity data positioned at respective positions corresponding to the respective similarity degree values of the respective pieces of similarity data on a line extending from the one end in a predetermined shape.

According to another aspect of the present invention, there is provided a program causing at least one computer to perform the method in the second aspect or a computer-readable storage medium in which such a program is recorded. The storage medium is a non-transitory medium.

### Advantageous Effects of Invention

According to the aspects, it is possible to easily and intuitively recognize similarity search results.

### BRIEF DESCRIPTION OF THE DRAWINGS

The above-described objects and other objects, features, and advantages are clarified more by the preferred example embodiments (which will be described below) and the following accompanying drawings.

FIG. 1 is a diagram conceptually illustrating a hardware configuration example of a display processing apparatus according to a first example embodiment.

FIG. 2 is a diagram conceptually illustrating a processing configuration example of the display processing apparatus according to the first example embodiment.

FIG. 3 is a diagram illustrating a first output example of a display in the first example embodiment.

FIG. 4 is a diagram illustrating a second output example of the display in the first example embodiment.

FIG. 5 is a flowchart illustrating an operation example of the display processing apparatus in the first example embodiment.

FIG. 6 is a diagram conceptually illustrating a processing configuration example of a display processing apparatus according to a second example embodiment.

FIG. 7 is a diagram illustrating a first output example of a display in the second example embodiment.

FIG. 8 is a diagram illustrating a second output example of the display in the second example embodiment.

FIG. 9 is a flowchart illustrating an operation example of the display processing apparatus in the second example embodiment.

FIG. 10 is a diagram illustrating an output example of a display in a modification example.

FIG. 11 is a diagram conceptually illustrating a processing configuration example of a display processing apparatus according to a third example embodiment.

FIG. 12 is a flowchart illustrating an operation example of the display processing apparatus in the third example embodiment.

### DESCRIPTION OF EMBODIMENTS

Hereinafter, example embodiments of the present invention will be described. Note that, example embodiments which will be described below are just examples, and the present invention is not limited to the configurations of the following example embodiments.

### First Example Embodiment

A display processing apparatus and a display processing method according to a first example embodiment will be described with reference to the drawings.

[Apparatus Configuration]

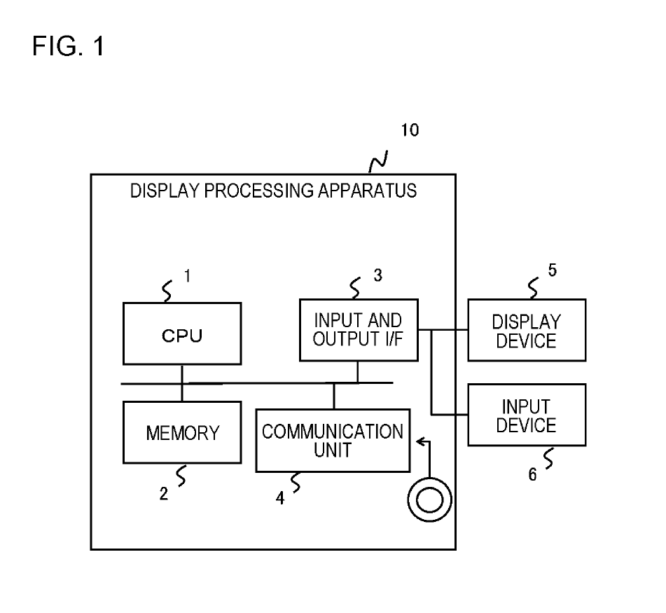

FIG. 1 is a diagram conceptually illustrating a hardware configuration example of a display processing apparatus 10 in the first example embodiment. The display processing apparatus 10 is a so-called computer. As illustrated in FIG. 1, the display processing apparatus includes a central processing unit (CPU) 1, a memory 2, an input and output interface (I/F) 3, a communication unit 4, and the like.

The CPU 1 includes an application specific integrated circuit (ASIC), a digital signal processor (DSP), a graphics processing unit (GPU), and the like in addition to a general CPU.

The memory 2 includes a random access memory (RAM), a read only memory (ROM), and an auxiliary storage device (hard disk and the like).

The input and output I/F 3 is connectable to a user interface device such as a display device 5 and an input device 6. The display device 5 is a device such as a liquid crystal display (LCD) or a cathode ray tube (CRT), which is configured to display a screen corresponding to drawing data processed by the CPU 1 and the like. The input device 6 is a device such as a keyboard or a mouse, which is configured to receive an input of a user operation. The display device 5 and the input device 6 may be integrated with each other, and thus may be implemented as a touch panel. The input and output I/F 3 may be connected to other pieces of equipment such as a printer.

For example, the communication unit 4 performs communication with another computer through a communication network (not illustrated) or performs transmission and reception of a signal to and from another piece of equipment. A portable storage medium or the like may also be connected to the communication unit 4.

The hardware configuration illustrated in FIG. 1 is just an example, and the hardware configuration of the display processing apparatus 10 is not limited to the example illustrated in FIG. 1. The display processing apparatus 10 may include other hardware elements which are not illustrated. The number of hardware elements is not limited to the example in FIG. 1. For example, the display processing apparatus 10 may include a plurality of CPUs 1.

[Processing Configuration]

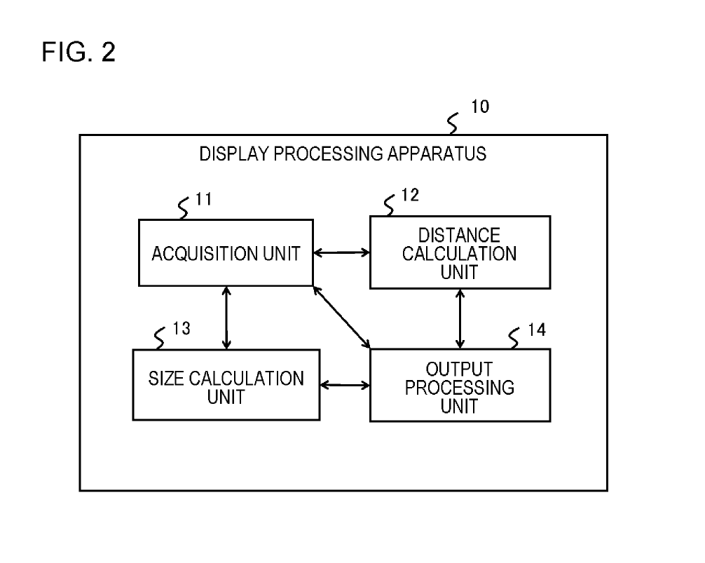

FIG. 2 is a diagram conceptually illustrating a processing configuration example of the display processing apparatus 10 in the first example embodiment. The display processing apparatus 10 includes an acquisition unit 11, a distance calculation unit 12, a size calculation unit 13, an output processing unit 14, and the like. The units are, for example, software elements implemented by the CPU 1 executing a program stored in the memory 2. For example, the program may be installed from a portable storage medium such as a compact disc (CD) or a memory card or from another computer on the network through the communication unit 4 and stored in the memory 2.

The acquisition unit 11 acquires information relating to a similarity search result, based on query data. The query data is data of an object to be searched, and includes multimedia data such as still images, moving images, voices, numbers, texts, and the like, and feature value data of the multimedia data. The similarity search based on query data may be performed by the display processing apparatus 10 or may be performed by another device. As a similarity search method, known methods may be used. Similarity data extracted by the similarity search also includes the above-described multimedia data and the feature value data of the multimedia data, similarly to the query data. A database on which the similarity search is performed may be provided in the display processing apparatus 10 or may be provided in another device.

For example, the acquisition unit 11 acquires query data, similarity data extracted by similarity search based on the query data, and a similarity degree value indicating the similarity between the query data and the similarity data. The number of pieces of similarity data extracted by the similarity search is not limited. The acquisition unit 11 may further acquire a search condition (threshold of the similarity degree value, and the like) used in the similarity search based on the query data. The acquisition unit 11 can acquire an image which describes contents of query data or an image which describes contents of similarity data, instead of or in addition to the query data and the similarity data. The image which describes contents of query data and the image which describes contents of similarity data are acquired in a case where the query data and the similarity data are not image data. The image indicating query data and the image indicating similarity data are disposed in respective regions indicating the query data and the similarity data by the output processing unit 14 which will be described later. The acquisition unit 11 may compare the acquired query data and the similarity data, and thus may calculate a similarity degree value itself. As described above, data extracted by the similarity search based on query data is collectively referred to as similarity data.

The acquisition unit 11 may acquire the above-described data and information from within the display processing apparatus 10 or from another device or a portable storage medium.

The distance calculation unit 12 calculates distances from the position at which the region indicating the query data is disposed to each of a plurality of pieces of similarity data acquired by the acquisition unit 11 based on a plurality of similarity degree values acquired by the acquisition unit 11. The calculation method is not limited as long as the greater the similarity degree value (higher similarity), the smaller the calculated distance. The region indicating the query data is a partial region within a display outputted by the output processing unit 14. The distance to be calculated indicates a distance in the display.

For example, the distance calculation unit 12 calculates a distance Dist(q, v) for similarity data v, by using an expression as follows:

Dist(q,v)=MINDIST+(MAXDIST−MINDIST)×(1−sim(q,v)).

sim(q, v) indicates a similarity degree value between query data q and the similarity data v. MIN_{DIST} indicates a distance in a case where the query data q and the similarity data v completely coincide with each other. MAX_{DIST} indicates a distance in a case where the query data q and the similarity data v do not completely coincide with each other (similarity degree value is zero) or a similarity degree value between the query data q and the similarity data v is smaller than a predetermined threshold. In this case, MIN_{DIST} and MAX_{DIST} are previously held by the distance calculation unit 12.

The size calculation unit 13 calculates sizes of each of the regions indicating the plurality of pieces of similarity data acquired by the acquisition unit 11, based on the plurality of similarity degree values acquired by the acquisition unit 11. A calculation method is not limited as long as the greater the similarity degree value (higher similarity), the greater the calculated size. The region indicating the similarity data is a partial region within the display outputted by the output processing unit 14. The size to be calculated indicates a size within the display.

For example, the size calculation unit 13 calculates the size Size(v) of the similarity data v by using an expression as follows:

Size(v)=sizeof(q)×sim(q,v).

sim(q, v) indicates a similarity degree value between the query data q and the similarity data v. “sizeof(q)” indicates a predetermined display size of the region indicating the query data q. The similarity degree value indicated by sim( ) has a value of equal to or greater than 0 and equal to or smaller than 1. Thus, according to the expression, the smaller the similarity degree value is (lower similarity), the smaller the calculated size is.

The output processing unit 14 outputs a display including the region indicating the query data disposed at one end and the plurality of regions indicating respective ones of the plurality of pieces of similarity data disposed at positions on a line extending from the one end in a predetermined shape. Each position corresponds to a similarity degree value of each piece of the similarity data. In a case where query data and similarity data are images, a region indicating the query data may be the query data (image) itself, and a region indicating the similarity data may be the similarity data (image) itself. In a case where query data and similarity data are feature value data of images, a region indicating the query data is an image corresponding to the query data (feature value data), and a region indicating the similarity data is an image corresponding to the similarity data (feature value data). Hereinafter, a region indicating query data may be referred to as a query provision region and a region indicating similarity data as a similarity provision region.

The output processing unit 14 previously holds information having a predetermined shape which is obtained by positioning the region indicating query data and regions indicating a plurality of pieces of similarity data in a line shape. As the predetermined shape, any shape, for example, a circle, an ellipse, a triangle, a hexagon, or other polygons is provided. A line shape which meanders from an end at which the query provision region is disposed or a line shape which circles around the end is preferable. The regions are positioned in such a line shape, and thus it is possible to cause a person who views the output to sensuously and easily recognize the degree of each piece of similarity data being separated from the query data.

The output processing unit 14 determines positions of the regions which indicate respective ones of the plurality of pieces of similarity data, on the line based on the distances calculated by the distance calculation unit 12. The output processing unit 14 determines positions of the regions on the line by using the information of the predetermined shape, which has been previously held, and the distances calculated by the distance calculation unit 12. Here, in a case where the predetermined shape is logarithmic spiral or equi-angular spiral, the output processing unit 14 disposes the query provision region at the center end thereof. The output processing unit 14 determines positions of respective similarity provision regions on the line by using the distances calculated by the distance calculation unit 12. The calculated distances are used as straight-line distances from the center end or as distances from the center end along a logarithmic spiral or equi-angular spiral line. In a case where the predetermined shape is a meandering line shape (snake-like shape), the output processing unit 14 disposes the query provision region at one end thereof. The output processing unit 14 determines positions of similarity provision regions on the line by using the distances calculated by the distance calculation unit 12 as distances from the end along the snake-like line. Thus, the degree of each piece of similarity data being separated from the query data, as it is, displays the similarity to the query data, and it is possible to cause a person who views the display to sensuously and easily recognize the similarity of each piece of similarity data with the query data.

Further, the output processing unit 14 can also position the regions (similarity provision regions) indicating the plurality of pieces of similarity data, according to the respective sizes calculated by the size calculation unit 13. As described above, the size of the similarity provision region, which is calculated by the size calculation unit 13 is increased as a similarity degree value of the corresponding similarity data with the query data becomes higher. In a case where the similarity provision region is disposed at the position corresponding to the distance calculated by the distance calculation unit 12, with the size calculated by the size calculation unit 13, the similarity provision region having high similarity is displayed so as to be close to the query provision region and have a large size. As a result, a near-far relation of each of the regions is indicated by the size. Thus, it is possible to display the similarity provision regions so as to become farther away from the query provision region in a depth direction of the display in a two-dimensional plane. That is, it is possible to perform a display such that the query provision region and the similarity provision regions are positioned so as to be three-dimensionally spiral, and it is possible to cause a person who views the display to sensuously and easily recognize the similarity of each piece of similarity data with the query data.

The output processing unit 14 may adjust the distances calculated by the distance calculation unit 12 and the sizes calculated by the size calculation unit 13, and determine the positions and the sizes of the similarity provision regions, so as not to overlap the similarity provision regions or so as to minimize overlapped portions. For example, the output processing unit 14 may extend or reduce the length of the predetermined shape in which the similarity provision regions are positioned in a line shape, based on distribution of the distances of all pieces of similarity data. In this case, the output processing unit 14 extends the length of the predetermined shape so that a difference between the distances which are most approximate to each other among distances of all the pieces of similarity data becomes equal to a predetermined length. In a case where there are a plurality of similarity provision regions having a difference between the distances that is within a predetermined threshold, the output processing unit 14 may display the similarity provision regions, for example, in the shape of stacked cards. The output processing unit 14 can also sequentially switch the similarity provision region displayed on the top layer, based on a user operation on the stacked shape. The output processing unit 14 can display the plurality of similarity provision regions having the difference between the distances that is within the predetermined threshold to be aligned within a representative region having a certain size that is disposed at a position corresponding to a representative distance. In this case, each of the similarity provision regions are displayed small within the representative region. However, a selected similarity provision region may be enlarged and displayed in accordance with a user operation.

In a case where the number of pieces of similarity data to be displayed is small, the distance between the similarity provision regions is large. Thus, it may not be possible to visually recognize the predetermined shape. Thus, the output processing unit 14 may switch whether or not the line having the predetermined shape is displayed by a solid line, a broken line, or the like, based on the number of pieces of similarity data to be displayed.

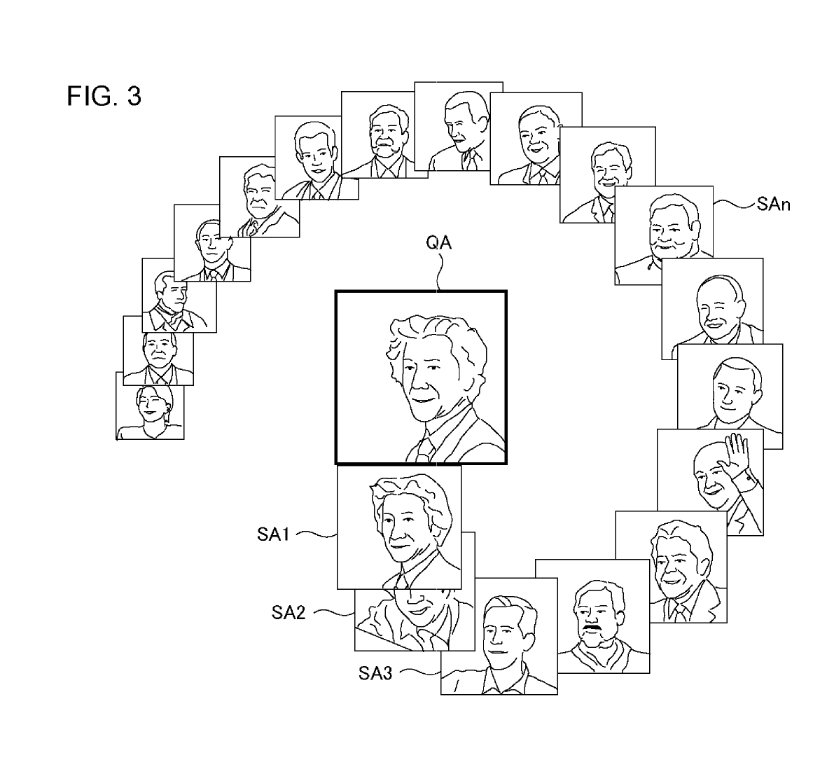

FIG. 3 is a diagram illustrating a first output example of the display in the first example embodiment. In the example in FIG. 3, query data and similarity data are feature value data of images. A query provision region QA indicates an image corresponding to the query data. Similarity provision regions SA1, SA2, SA3, and SAn indicate images corresponding to respective pieces of similarity data. In this case, the output processing unit 14 outputs a display including the query provision region QA disposed at the center end, and the plurality of similarity provision regions SA1, SA2, SA3, and SAn positioned on a line extending from the end so as to be spiral. The similarity provision region SA1 indicates an image corresponding to similarity data having the highest similarity degree value with the query data. The similarity provision region SA1 is disposed with the largest size among the sizes of the similarity provision regions, so as to be closest to the query provision region QA. The similarity provision region SA2 indicates an image corresponding to similarity data having the second highest similarity degree value. The similarity provision region SA2 is disposed with the second largest size among the sizes of the similarity provision regions, so as to be secondly closest to the query provision region QA. The similarity provision region SA3 indicates an image corresponding to similarity data having the third highest similarity degree value. The similarity provision region SA3 is disposed with the third largest size among the sizes of the similarity provision regions, so as to be thirdly closest to the query provision region QA. In the example in FIG. 3, the output processing unit 14 displays an outer frame for the query provision region QA, in order to easily distinguish the query provision region from other regions.

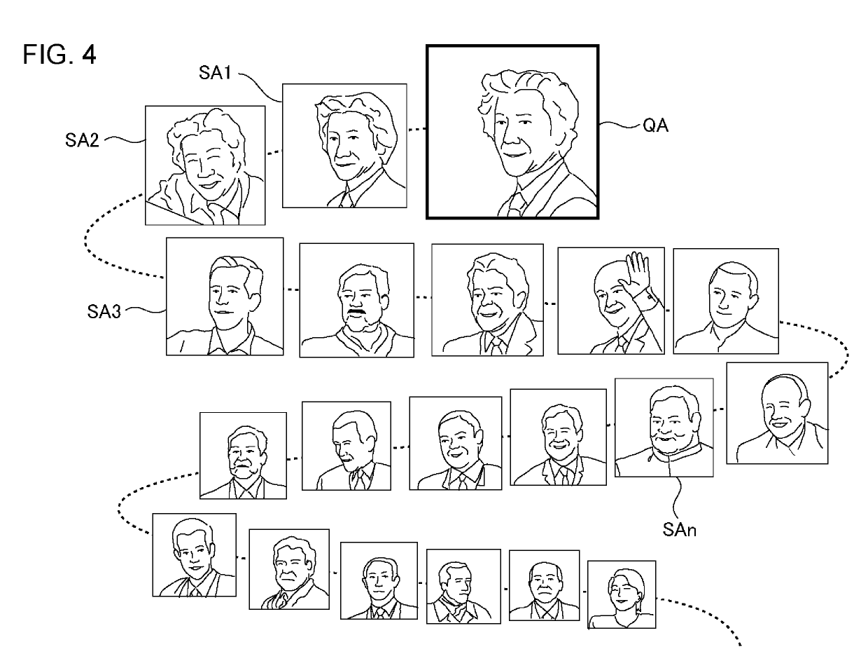

FIG. 4 is a diagram illustrating a second output example of the display in the first example embodiment. In the example in FIG. 4, the output processing unit 14 outputs a display in which the query provision region QA is disposed at an upper end, and the plurality of similarity provision regions SA1, SA2, SA3, and SAn are positioned on a line which meanders (meanderingly) and extends from the end. FIG. 4 is different from FIG. 3 in that the predetermined shape obtained by positioning the region indicating the query data and the regions indicating the plurality of pieces of similarity data in a line shape is different. In FIG. 3, the regions are positioned to be logarithmic spiral or equi-angular spiral. In FIG. 4, the regions are positioned to have a snake shape.

The display output by the output processing unit 14 is not limited to the examples in FIGS. 3 and 4. For example, in the form in FIG. 3, the query provision region QA may be disposed at the other end (end on the outer side). In this case, the region indicating similarity data which has lower similarity is disposed as the region becomes closer to the center end. In the form in FIG. 4, the query provision region QA may be disposed at the other end (lower end). In this case, the region indicating similarity data which has lower similarity is disposed as the region becomes closer to the upper end.

The output processing unit 14 may output the display to the display device 5 or may output the display to another output device such as a printer (not illustrated). The output processing unit 14 may output the display to the display device of another computer. In this case, the output processing unit 14 transmits data of the display to this computer by communication through the communication unit 4. An output of the display also includes an output of a file which allows the display. In this case, the output processing unit 14 may generate a file which allows the display and transmit the generated file to another computer. The output processing unit 14 may store the generated file in a portable storage medium. As described above, an output form of the display is not limited.

### Operation Example

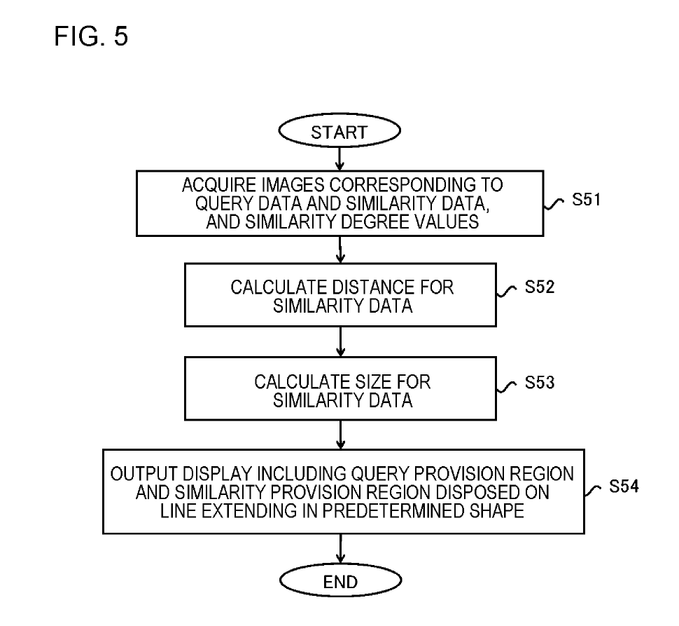

A display processing method in the first example embodiment will be described below with reference to FIG. 5. FIG. 5 is a flowchart illustrating an operation example of the display processing apparatus 10 in the first example embodiment. As illustrated in FIG. 5, the display processing method in the first example embodiment is performed by at least one computer such as the display processing apparatus 10. For example, processes illustrated in FIG. 5 are performed by the above-described units which are included in the display processing apparatus 10. The processes illustrated in FIG. 5 are similar to processing details of the above-described units. Thus, details of each of the processes will not be repeated.

The display processing apparatus 10 acquires information relating to a result of similarity search based on query data (S51). For example, the display processing apparatus 10 acquires an image corresponding to the query data, images corresponding to pieces of similarity data, and similarity degree values between the query data and each piece of similarity data (S51). In a case where the query data and the similarity data are feature value data of voices, the display processing apparatus 10 acquires images indicating respective details of the voices. The descriptions of the query data and the similarity data are as described above (acquisition unit 11).

The display processing apparatus 10 calculates, for each of pieces of similarity data which correspond to the respective images acquired in (S51), a distance thereto from a position at which the image (query provision region) corresponding to the query data is disposed, based on the similarity degree values acquired in (S51) (S52). The descriptions of the calculation method of the distance are as described above (distance calculation unit 12).

The display processing apparatus 10 calculates sizes of the pieces of similarity data which correspond to the images acquired in (S51), based on the similarity degree values acquired in (S51) (S53). The sizes to be calculated are the sizes of images (similarity provision region) corresponding to the respective pieces of similarity data. The descriptions of the calculation method of the size are as described above (size calculation unit 13).

The display processing apparatus 10 outputs a display in which the image (query provision region) corresponding to the query data is disposed at one end, and the images (similarity provision regions) corresponding to the respective pieces of similarity data are positioned on a line which extends from the one end in a predetermined shape (S54). At this time, the display processing apparatus 10 determines the position of each of the images which correspond to the respective pieces of similarity data, on the line, based on the distance calculated in (S52). Further, the display processing apparatus 10 determines the size of each of the images which correspond to the respective pieces of similarity data, based on the size calculated in (S53). The descriptions of such a method of outputting a display are also as described above (output processing unit 14).

An order of performing the processes constituting the display processing method in the first example embodiment is not limited to the example illustrated in FIG. 5. The order of performing the processes can be changed in a range without causing a problem in content. For example, the order of performing the processes of (S52) and (S53) may be reversed or the processes of (S52) and (S53) may be performed together.

[Advantageous Effect of First Example Embodiment]

As described above, in the first example embodiment, the similarity degree value between query data and similarity data extracted by similarity search based on the query data is acquired, and the position and the size of the similarity data are calculated based on the acquired similarity degree value. Thus, a display in which the region indicating the query data is disposed at one end and the plurality of regions which indicate respective ones of the plurality of pieces of similarity data are disposed at the calculated positions on the line which extends from the one end in a predetermined shape, in accordance with the calculated sizes. As described above, in the first example embodiment, the degree of similarity between the query data and each piece of similarity data is indicated by a near-far relation between the region indicating the query data and the region indicating each piece of similarity data and by the relation of the sizes between the regions indicating the pieces of similarity data. Thus, in the first example embodiment, it is possible to quantitatively express the degree of similarity between the query data and the pieces of similarity data, and to express the degree of similarity so as to easily recognize the degree of similarity. As a result, according to the first example embodiment, it is possible to cause a person who views a result of similarity search to intuitively and directly recognize the result.

In the first example embodiment, the predetermined shape is set to be a shape of a line which meanders from an end at which the region indicating query data is disposed, or to be a shape of a line which circles around the end. Such a shape allows a person trying to grasp a sense of the distance from the end (position of the region indicating the query data) as the reference to a piece of similarity data intuitively recognize the distance. Accordingly, by outputting a display including a region indicating query data and a region indicating a piece of similarity data positioned in such a form, it is possible to allow a person who views a result of similarity search to more easily recognize the result.

### Second Example Embodiment

There exists a database in which data is managed in a hierarchical structure, for example, a database to which an index tree is applied. As a construction method of the index tree, as disclosed in Patent Documents 1 and 2, various methods are provided. For example, in Patent Document 2, a construction method of an index having a tree structure which is tiered based on similarity between pieces of data is provided. In the second example embodiment, a display method is implemented which is effective in a case where pieces of similarity data extracted by similarity search are managed in a hierarchical structure. A display processing apparatus 10 and a display processing method according to the second example embodiment will be described below focusing on contents which are different from those in the first example embodiment. In the following descriptions, details which are similar to those in the first example embodiment will not be repeated.

[Processing Configuration]

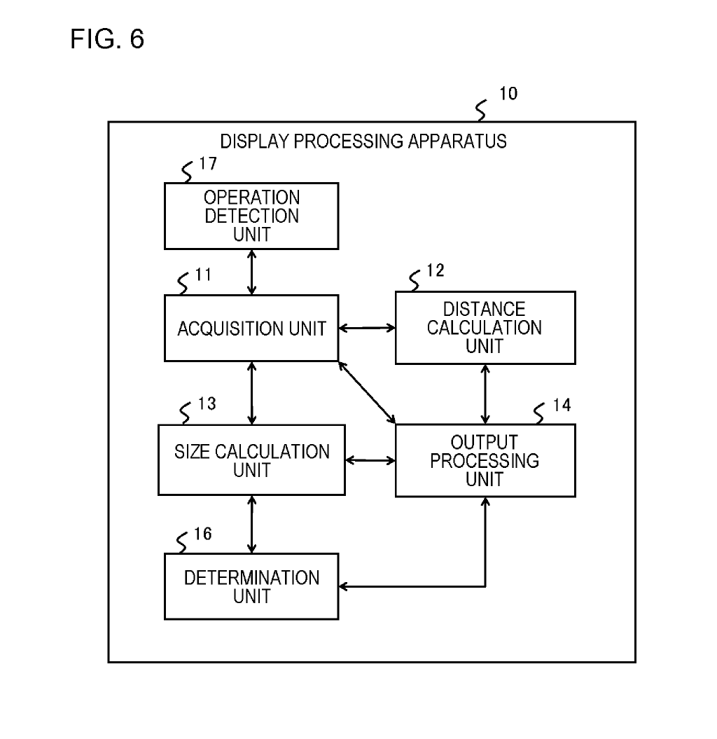

FIG. 6 is a diagram conceptually illustrating a processing configuration example of the display processing apparatus 10 in the second example embodiment. In the second example embodiment, the display processing apparatus 10 further includes a determination unit 16 and an operation detection unit 17, in addition to the configuration of the first example embodiment. The units are also software elements implemented in a manner that the CPU 1 executes a program stored in the memory 2, for example.

In a case where similarity data is managed in the hierarchical structure, the acquisition unit 11 acquires hierarchical structure information of the similarity data. As an example of the hierarchical structure information, index tree information is exemplified. The acquisition unit 11 requests another device, configured to manage hierarchical structure, information of a database, so as to acquire hierarchical structure information of similarity data from this device. The acquisition unit 11 can acquire the hierarchical structure information of similarity data by directly referring to the hierarchical structure information of the database. The acquisition unit 11 may acquire only information of a lower-order layer lower than the similarity data, or may acquire information of a higher-order layer higher than the similarity data in addition to the information of the lower-order layer. Hereinafter, data of the lower-order layer of similarity data may also be described as lower-order data.

For example, in a case where similarity data includes data of a lower-order layer, the acquisition unit 11 acquires images which indicate the lower-order data or indicates contents of the lower-order data and a similarity degree value between the lower-order data and the similarity data, as the hierarchical structure information. The acquisition unit 11 may acquire all pieces of the lower-order data corresponding to all levels which are lower than that of the similarity data, or may acquire only lower-order data of a level which is lower by one level than that of the similarity data.

The determination unit 16 determines whether or not similarity data extracted by similarity search based on query data includes data of a lower-order layer. The determination unit 16 can perform the determination based on the hierarchical structure information acquired by the acquisition unit 11. The similarity data which is determined to include the lower-order data by the determination unit 16 is distinguishable from similarity data which does not include lower-order data, in a display outputted by the output processing unit 14.

The operation detection unit 17 detects a user operation on a region indicating similarity data which includes data of a lower-order layer, in the display which is outputted by the output processing unit 14 to be described later. The operation detection unit 17 detects a user operation based on input information of a user received by the input device 6.

The output processing unit 14 outputs a display in which a region indicating the similarity data which has been determined to include lower-order data by the determination unit 16 is disposed in a state distinguishable from a region indicating similarity data which does not include lower-order data. For example, the output processing unit 14 causes both regions to be in a state distinguishable from each other, in a manner that an outer frame of a predetermined color is added to the region indicating similarity data which includes lower-order data, and an outer frame is not added to the other region indicating similarity data which does not include lower-order data. As another example, the output processing unit 14 adds a predetermined mark to the region indicating the similarity data which includes lower-order data and does not add the mark to the region indicating the similarity data which does not include the lower-order data. The display method is not limited as long as both the regions are displayed so that the regions are distinguished from each other.

In a case where the operation detection unit 17 detects the user operation, the output processing unit 14 further outputs a display as follows, related to the similarity data selected by the user operation, based on hierarchical structure information of the similarity data. The output processing unit 14 further outputs a display in which a region indicating the similarity data is disposed at one end, and a plurality of regions which indicate pieces of lower-order data of the similarity data are positioned at respective positions corresponding to similarity degree values of the pieces of lower-order data, on a line which extends from the one end in a predetermined shape. The predetermined shape may be a shape which is the same as or different from that in a case of setting query data as a reference. The position and the size of the region indicating each piece of the lower-order data are determined by using the distance and the size calculated by the distance calculation unit 12 and the size calculation unit 13 based on the similarity degree value indicating a similarity between the similarity data and the corresponding lower-order data.

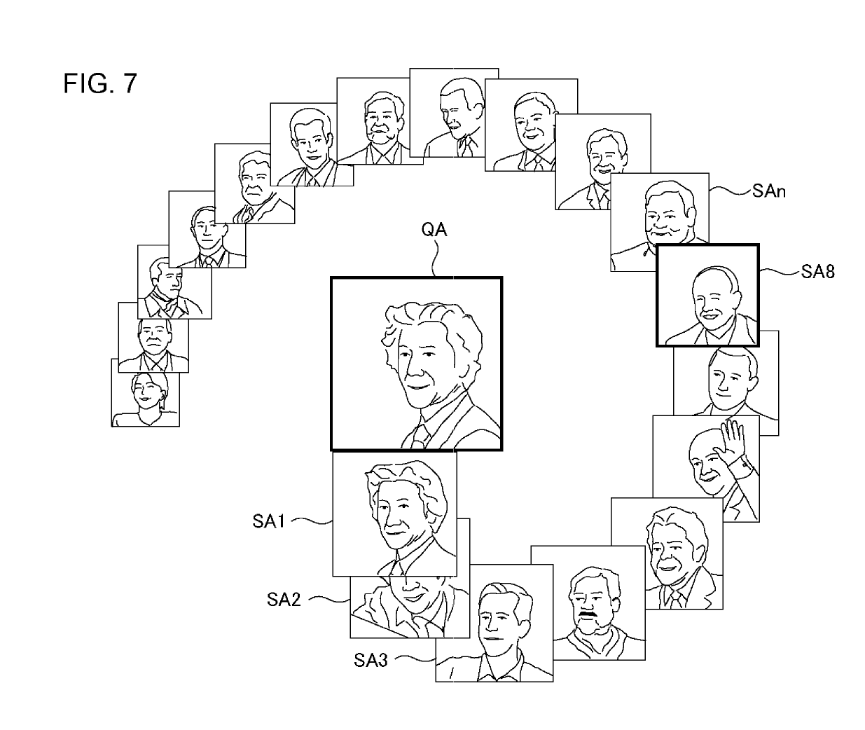

FIG. 7 is a diagram illustrating a first output example of a display in the second example embodiment. In the example in FIG. 7, an outer frame is added to a similarity provision region SA8. The outer frame indicates that the similarity data indicated by the region SA8 includes lower-order data. No outer frames are added to similarity provision regions SA1, SA2, and SA3, and thus it is indicated that pieces of similarity data indicated by these regions do not include lower-order data.

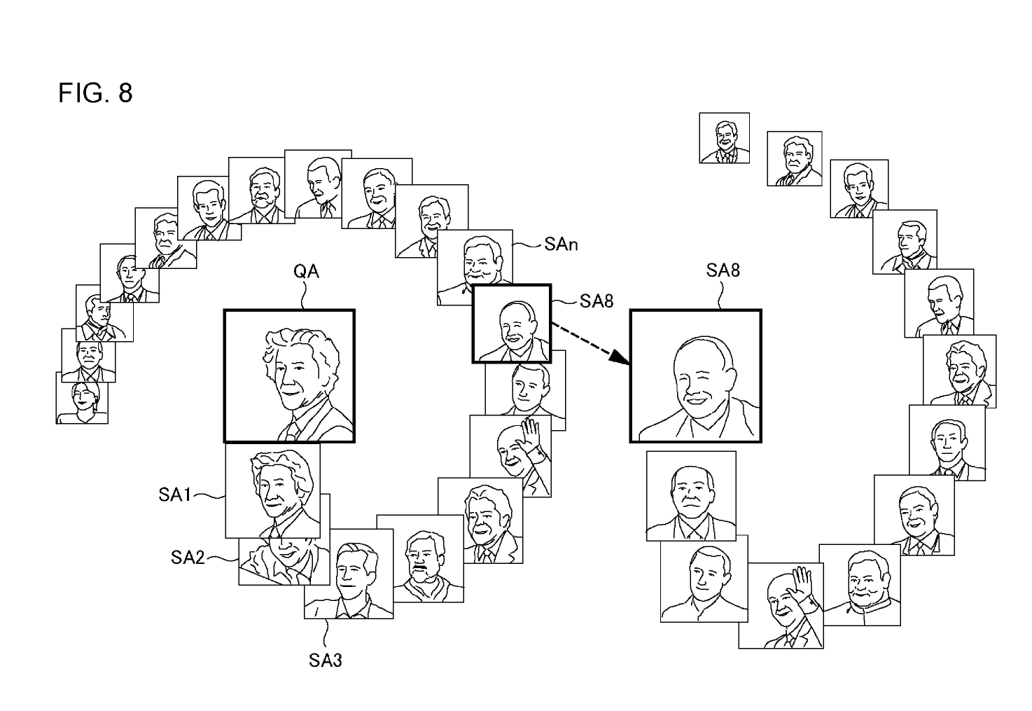

FIG. 8 is a diagram illustrating a second output example of the display in the second example embodiment. According to the example in FIG. 8, the region SA8 indicating similarity data which includes lower-order data is operated by a user, and thus a display in which the similarity data indicated by the region SA8 and the lower-order data of the similarity data are arranged on a line having a predetermined shape is further output. The similarity data indicated by the region SA8 is disposed at the center end. Regions which indicate pieces of lower-order data of the similarity data are disposed at positions corresponding to similarity degree values between the pieces of lower-order data and the similarity data, on the line. That is, the region indicating lower-order data which has a higher similarity degree value is disposed to be closer to the region indicating the similarity data. The region indicating lower-order data which has a higher similarity degree value is displayed with a larger size.

### Operation Example

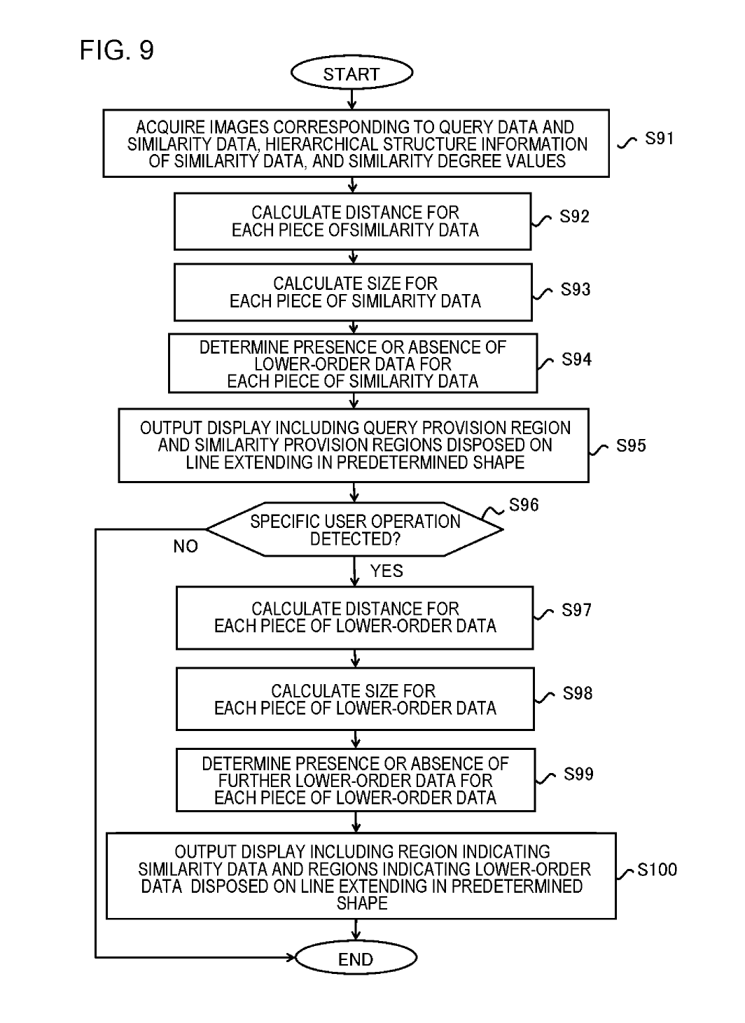

A display processing method in the second example embodiment will be described below with reference to FIG. 9. FIG. 9 is a flowchart illustrating an operation example of the display processing apparatus 10 in the second example embodiment. As illustrated in FIG. 9, the display processing method in the second example embodiment is performed by at least one computer such as the display processing apparatus 10. For example, processes illustrated in FIG. 9 are performed by the above-described units which are included in the display processing apparatus 10. The processes illustrated in FIG. 9 are similar to processing details of the above-described units. Thus, details of each of the processes will not be repeated.

Similar to the first example embodiment, the display processing apparatus 10 acquires information relating to a result of similarity search based on query data (S91). In the second example embodiment, the display processing apparatus 10 further acquires hierarchical structure information of similarity data extracted by similarity search, in addition to the information acquired in the first example embodiment. The acquired hierarchical structure information includes, for example, an image which indicates lower-order data or indicates contents of the lower-order data, and a similarity degree value between the lower-order data and the similarity data.

The display processing apparatus 10 performs (S92) and (S93). (S92) is similar to (S52) in the first example embodiment and (S93) is similar to (S53) in the first example embodiment.

The display processing apparatus 10 determines whether or not the similarity data includes lower-order data, based on the hierarchical structure information acquired in (S91), for each piece of similarity data (S94).

The display processing apparatus 10 outputs a display in which the image (query provision region) corresponding to the query data is disposed at one end, and the images (similarity provision regions) corresponding to the respective pieces of similarity data are positioned on a line which extends from the one end in a predetermined shape (S95). At this time, the display processing apparatus 10 determines the position of each of the images which correspond to the respective pieces of similarity data, on the line, based on the distance calculated in (S92). At this time, the display processing apparatus 10 determines the position of each of the images which correspond to the pieces of similarity data, on the line, based on the distance calculated in (S92). Further, the display processing apparatus 10 determines the size of each of the images which correspond to the respective pieces of similarity data, based on the size calculated in (S93). In the second example embodiment, the display processing apparatus 10 causes the region indicating the similarity data which has been determined to include the lower-order data in (S94) to be disposed in a state distinguishable from a region indicating similarity data which does not include lower-order data. The descriptions of such a method of outputting a display are also as described above (output processing unit 14).

The display processing apparatus 10 detects a user operation on the region indicating the similarity data which includes the data of a lower-order layer, in the display which is output in (S95) (S96). In a case where the display processing apparatus 10 does not detect such a user operation (in FIG. 9, described as a specific user operation) (NO in S96), the display processing apparatus 10 ends the process.

On the other hand, if the display processing apparatus 10 detects such a user operation (YES in S96), the display processing apparatus 10 performs (S97), (S98), and (S99) on each piece of lower-order data of the similarity data selected by the user operation. In (S97) and (S98), the display processing apparatus 10 calculates the distance and the size for each piece of the lower-order data by methods which are similar to those in (S92) and (S93), based on a similarity degree value between the similarity data selected by the user operation and each piece of lower-order data. The display processing apparatus 10 determines whether or not each piece of lower-order data includes further lower-order data, based on the hierarchical structure information acquired in (S91) (S99).

The display processing apparatus 10 outputs a display in which an image corresponding to the similarity data selected by the user operation detected in (S96) is disposed at one end, and images which correspond to respective pieces of lower-order data of the similarity data are disposed on a line which extends from the one end in a predetermined shape (S100). At this time, the display processing apparatus 10 determines the position of each of the images which correspond to the respective pieces of lower-order data, on the line, based on the distance calculated in (S97). Further, the display processing apparatus 10 determines the size of each of the images which correspond to the respective pieces of lower-order data, based on the size calculated in (S98). Further, the display processing apparatus 10 causes the region indicating the lower-order data which has been determined to include the further lower-order data in (S99) to be disposed in a state distinguishable from a region indicating lower-order data which does not have further lower-order data.

An order of performing the processes constituting the display processing method in the second example embodiment is not limited to the example illustrated in FIG. 9. The order of performing the processes can be changed in a range without causing a problem in content. For example, the order of performing (S92), (S93), and (S94) may be switched or performed together. The order of performing (S97), (S98), and (S99) may be switched or performed together.

FIG. 9 does not refer to a case where a user operation is detected on the region indicating lower-order data. However, in this case, the processes of (S96) to (S100) may be performed by using, as a target, the further lower-order data of the lower-order data selected by the user operation. In the second example embodiment, (S99) may not be performed. In this case, the display is performed in a state where a region indicating lower-order data which includes further lower-order data is not distinguishable from a region indicating lower-order data which does not include further lower-order data.

[Advantageous Effect of Second Example Embodiment]

As described above, in the second example embodiment, similarity data which includes data of a lower-order layer is displayed in a state where the similarity data is distinguishable from similarity data which does not include data of a lower-order layer. If a region indicating similarity data which includes data of a lower-order layer is operated, a display is outputted in which the data of a lower-order layer of the similarity data is disposed on a line having a predetermined shape, by using the similarity data as a reference.

Thus, according to the second example embodiment, in addition to the similarity search results based on the query data, the similarity relation between each piece of similarity data extracted by similarity search and data of a lower-order layer is easily recognized.

### Modification Example

In the above-described second example embodiment, a similarity relationship is displayed between similarity data and lower-order data of the similarity data. However, the display above is not limited to such an example. Similarity search may be performed by using similarity data selected by a user operation, as query data, and a result obtained by the similarity search may be displayed. Specifically, when the output processing unit 14 displays a similarity relation between query data and similarity data, and then a certain similitude provision region is selected by a user operation, the output processing unit 14 displays a result of similarity search by using similarity data corresponding to the selected region, as query data. For example, the output processing unit 14 causes the acquisition unit 11 to acquire a result of similarity search by using the selected similarity data as query data, and outputs a display based on the acquired information by using a method which is similar to that in the first example embodiment.

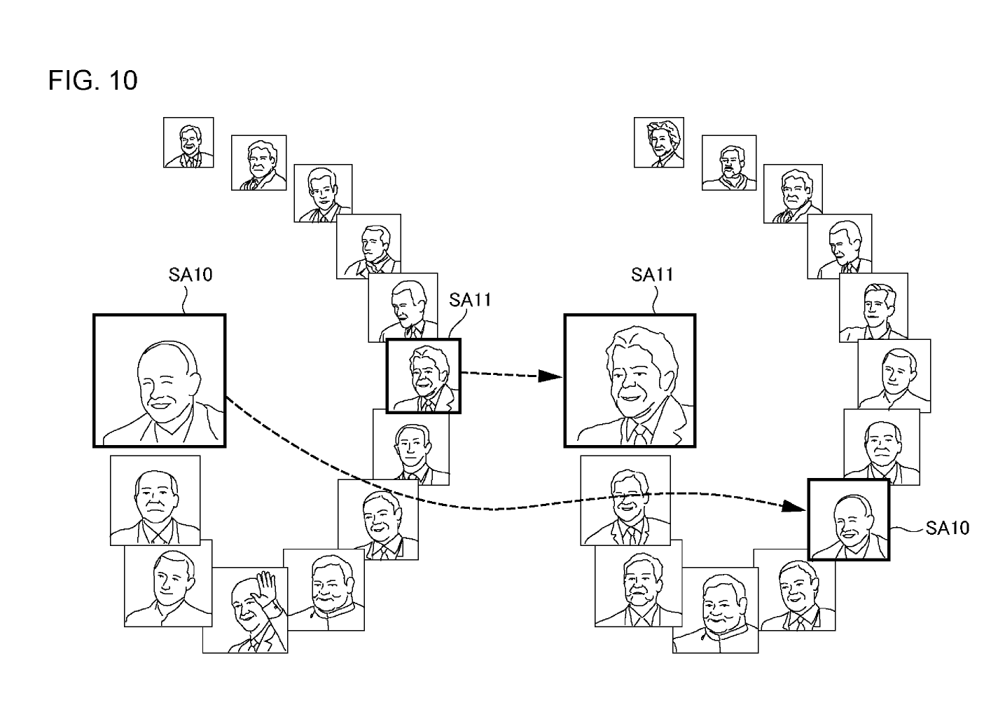

FIG. 10 is a diagram illustrating an output example of a display in a modification example. In the example in FIG. 10, a result of similarity search based on query data indicated by a region SA10 is illustrated on the left side. In the left-side display, if a region SA11 is selected by a user operation, a result of similarity search by using similarity data corresponding to the region SA11, as query data is displayed. In the example in FIG. 10, in a display illustrated on the right side, the region SA11 corresponds to query data and images corresponding to the region SA10 are extracted as a result of similarity search based on the query data.

### Third Example Embodiment

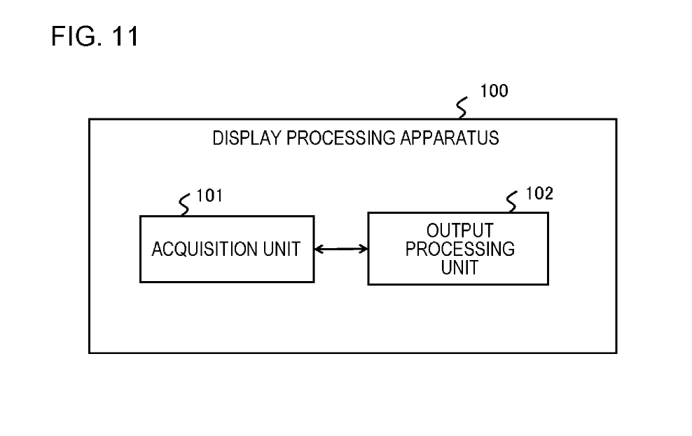

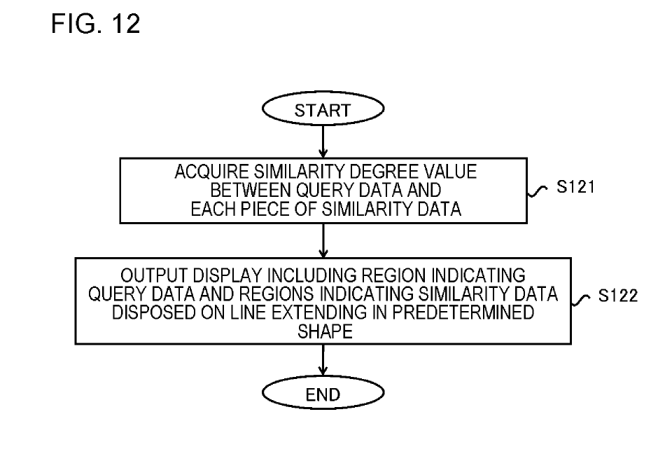

A display processing apparatus and a display processing method according to a third example embodiment will be described below with reference to FIGS. 11 and 12. The third example embodiment may be a program causing at least one computer to perform the display processing method, or may be a computer-readable storage medium in which such a program is recorded and read by the at least one computer.

FIG. 11 is a diagram conceptually illustrating a processing configuration example of the display processing apparatus in the third example embodiment. As illustrated in FIG. 11, a display processing apparatus 100 includes an acquisition unit 101 and an output processing unit 102. The display processing apparatus 100 illustrated in FIG. 11 has a hardware configuration, for example, which is similar to that of the above-described display processing apparatus 10 illustrated in FIG. 1. The above-described units are implemented by processing a program in a manner similar to that in the display processing apparatus 10. The display device 5 and the input device 6 may not be connected to the display processing apparatus 100. In a case where the display device 5 and the input device 6 are not connected, the display processing apparatus 100 functions as a WEB server, and thus provides display data for a client terminal.

The acquisition unit 101 acquires, for each of a plurality of pieces of similarity data extracted by similarity search based on query data, a similarity value indicating similarity with the query data. The acquisition unit 101 itself may calculate the similarity degree value or the acquisition unit 101 may acquire the similarity degree value from another device or a storage medium. A specific example of the acquisition unit 101 corresponds to the above-described acquisition unit 11.

The output processing unit 102 outputs a display in which a region indicating query data is disposed at one end and a plurality of regions which indicate respective ones of a plurality of pieces of similarity data are disposed at positions on a line which extends from the one end in a predetermined shape. The positions correspond to respective similarity degree values of the pieces of similarity data. The output processing unit 102 outputs the display to the display device 5 which is connected to the display processing apparatus 100 or another device. The output processing unit 102 may output the display to another output device such as a printer (not illustrated). An output of the display also includes an output of a file which implements the display. In this case, the output processing unit 102 may generate a file which implements the display and transmit the generated file to another computer. The output processing unit 102 may store the generated file in a portable storage medium. As described above, an output form of the display is not limited.

In this example embodiment, the predetermined shape is not limited. The predetermined shape may be the shapes exemplified in the first example embodiment and the second example embodiment which are described above, or may be a shape other than the above shapes. As the predetermined shape, a shape is desirable which allows easy and intuitive recognition of a similarity relation between query data or similarity data, as a reference, and another piece of data.

The disposed positions of the regions indicating the respective pieces of similarity data corresponding to the respective similarity degree values may be determined based on the distances calculated by the distance calculation unit 12 described in the above example embodiments. The regions which indicate respective pieces of similarity data may be simply positioned in an order from the region having the highest similarity degree value.

FIG. 12 is a flowchart illustrating an operation example of the display processing apparatus 100 in the third example embodiment. As illustrated in FIG. 12, the display processing method in the third example embodiment is performed by at least one computer such as the display processing apparatus 100. For example, processes illustrated in FIG. 12 are performed by the above-described units which are included in the display processing apparatus 100.

The display processing method in this example embodiment includes a process of (S121) and a process of (S122).

In the process of (S121), the display processing apparatus 100 acquires, for each of a plurality of pieces of similarity data extracted by similarity search based on query data, a similarity degree value indicating a similarity with the query data.

In the process of (S122), the display processing apparatus 100 outputs a display in which a region indicating query data is disposed at one end and a plurality of regions which indicate respective ones of a plurality of pieces of similarity data are disposed at positions on a line which extends from the one end in a predetermined shape. The positions correspond to respective similarity degree values of the pieces of similarity data.

Details of the process of (S121) are similar to the processing details of the acquisition unit 101. Details of the process of (S122) are similar to the processing details of the output processing unit 102.

In the third example embodiment, a display is outputted in which a region indicating query data is disposed at one end and a plurality of regions which indicate respective ones of a plurality of pieces of similarity data are disposed at respective positions which correspond to respective similarity degree values of the pieces of similarity data, on a line which extends from the one end in a predetermined shape. In this display, the regions which indicate the respective pieces of similarity data are disposed at the respective positions corresponding to respective similarity degree values indicating similarities with the query data, on the line. Thus, according to the third example embodiment, it is possible to allow a person who views the outputted display to intuitively recognize the similarity relationship between the query data and each piece of the similarity data.

Note that, in the plurality of flowcharts used in the above descriptions, a plurality of processes are described in order. However, the order of performing the processes in the example embodiments is not limited to the order described in the example embodiments. In each of the example embodiments, the order of performing the illustrated processes can be changed in a range without causing a problem in content. The example embodiments and the modification example which are described above can be combined in a range without being contradictory.

A portion or the entirety of each of the example embodiments and the modification example may also be determined as follows. However, the example embodiments and the modification example are not limited to the following descriptions.

1. A display processing apparatus including:

an acquisition unit configured to acquire, for each of a plurality of pieces of similarity data extracted by similarity search based on query data, a similarity degree value indicating a similarity with the query data; and

an output processing unit configured to output a display including a region indicating the query data positioned at one end and a plurality of regions indicating respective ones of the plurality of pieces of similarity data positioned at respective positions corresponding to the respective similarity degree values of the respective pieces of similarity data, on a line extending from the one end in a predetermined shape.

2. The display processing apparatus according to 1,

in which the output processing unit outputs the display in which the plurality of regions indicating the respective ones of the plurality of pieces of similarity data are positioned on the line which meanders from the one end at which the region indicating the query data is positioned or on the line which circles around the one end.

3. The display processing apparatus according to 1 or 2, further including:

a distance calculation unit configured to calculate, for each of the plurality of pieces of similarity data, a distance thereto from the one end at which the region indicating the query data is positioned, along the line or on a straight line, based on the acquired plurality of similarity degree values,

in which the output processing unit determines each of the positions of the plurality of regions indicating the respective ones of the plurality of pieces of similarity data, based on the calculated distances.

4. The display processing apparatus according to any one of 1 to 3, further including:

a size calculation unit configured to calculate respective sizes of the plurality of regions indicating the respective ones of the plurality of pieces of similarity data, based on the acquired plurality of similarity degree values,

in which the output processing unit positions the plurality of regions indicating the respective ones of the plurality of pieces of similarity data according to the respective calculated sizes.

5. The display processing apparatus according to any one of 1 to 4, further including:

a determination unit configured to determine whether or not each of the plurality of pieces of similarity data includes data of a lower-order layer,

in which the output processing unit outputs the display in which a region indicating a piece of similarity data which includes data of a lower-order layer is positioned in a state distinguishable from a region indicating a piece of similarity data which does not include data of a lower-order layer.

6. The display processing apparatus according to 5, further including:

an operation detection unit configured to detect a user operation on the region indicating the piece of similarity data which includes the data of the lower-order layer in the output display, in which the acquisition unit acquires a similarity degree value between the piece of similarity data and each of a plurality of pieces of lower-order data in the lower-order layer of the piece of similarity data, and

in a case where the user operation is detected, the output processing unit further outputs a display in which the region indicating the piece of similarity data is positioned at one end and a plurality of regions indicating respective ones of the plurality of pieces of lower-order data are positioned on a line which extends from the one end in a predetermined shape at respective positions corresponding to the respective similarity degree values of the pieces of lower-order data.

7. A display processing method performed by at least one computer, the method including:

acquiring, for each of a plurality of pieces of similarity data extracted by similarity search based on query data, a similarity degree value indicating a similarity with the query data; and

outputting a display including a region indicating the query data positioned at one end and a plurality of regions indicating respective ones of the plurality of pieces of similarity data positioned at respective positions corresponding to the respective similarity degree values of the respective pieces of similarity data on a line extending from the one end in a predetermined shape.

8. The display processing method according to 7,

in which the predetermined shape is a line-like shape which meanders from the end or a line-like shape which circles around the end.

9. The display processing method according to 7 or 8, further including:

calculating, for each of the plurality of pieces of similar data, a distance thereto from the one end at which the region indicating the query data is positioned, along the line or on a straight line, based on the plurality of the acquired similarity degree values,

in which, in the step of outputting of the display, the positions of the plurality of regions indicating respective ones of the plurality of pieces of similarity data are determined based on the calculated distances.

10. The display processing method according to any one of 7 to 9, further including:

calculating, for each of the plurality of regions indicating the respective ones of the plurality of pieces of similarity data, a size of the region, based on the acquired plurality of similarity degree values,

in which, in the step of outputting the display, the plurality of regions indicating the respective ones of the plurality of pieces of similarity data are positioned according to the respective calculated sizes.

11. The display processing method described in any of 7 to 10, further including: determining whether or not each of the plurality of pieces of similarity data includes data of a lower-order layer,

in which, in the step of outputting the display, in the display, a region indicating a piece of similarity data which includes data of a lower-order layer is positioned in a state distinguishable from a region indicating a piece of similarity data which does not include data of a lower-order layer.

12. The display processing method according to 11 further including:
detecting a user operation on the region indicating the piece of similarity data which includes the data of the lower-order layer in the output display,

acquiring a similarity degree value between the piece of similarity data and each of a plurality of pieces of lower-order data in the lower-order layer of the piece of similarity data, and

in a case where the user operation is detected, outputting a display including the region indicating the piece of similarity data positioned at one end and a plurality of regions indicating respective ones of the plurality of pieces of lower-order data positioned on a line extending from the one end in a predetermined shape at respective positions corresponding to the respective similarity degree values of the pieces of lower-order data.

13. A program causing at least one computer to perform the display processing method described in any one of 7 to 12

This application claims priority based on Japanese Patent Application No. 2015-158366 filed on Aug. 10, 2015, the disclosure of which is incorporated herein in its entirety.

1. A display processing apparatus comprising:
an acquisition unit configured to acquire, for each of a plurality of pieces of similarity data extracted by similarity search based on query data, a similarity degree value indicating a similarity with the query data; and
an output processing unit configured to output a display including a region indicating the query data positioned at one end and a plurality of regions indicating respective ones of the plurality of pieces of similarity data positioned at respective positions corresponding to the respective similarity degree values of the respective pieces of similarity data, on a line extending from the one end in a predetermined shape.

2. The display processing apparatus according to claim 1,
wherein the output processing unit outputs the display including the plurality of regions indicating the respective ones of the plurality of pieces of similarity data positioned on the line which meanders from the one end at which the region indicating the query data is positioned or on the line which circles around the one end.

3. The display processing apparatus according to claim 1, further comprising:
a distance calculation unit configured to calculate, for each of the plurality of pieces of similarity data, a distance thereto from the one end at which the region indicating the query data is positioned, along the line or on a straight line, based on the acquired plurality of similarity degree values,
wherein the output processing unit determines each of the positions of the plurality of regions indicating the respective ones of the plurality of pieces of similarity data, based on the calculated distances.

4. The display processing apparatus according to claim 1, further comprising:
a size calculation unit configured to calculate, for each of the plurality of regions indicating the respective ones of the plurality of pieces of similarity data, a size of the region, based on the acquired plurality of similarity degree values,
wherein the output processing unit positions the plurality of regions indicating the respective ones of the plurality of pieces of similarity data according to the respective calculated sizes.

5. The display processing apparatus according to claim 1, further comprising:
a determination unit configured to determine whether or not each of the plurality of pieces of similarity data includes data of a lower-order layer,
wherein the output processing unit outputs the display including a region indicating a piece of similarity data which includes data of a lower-order layer positioned in a state distinguishable from a region indicating a piece of similarity data which does not include data of a lower-order layer.

6. The display processing apparatus according to claim 5, further comprising:
an operation detection unit configured to detect a user operation on the region indicating the piece of similarity data which includes the data of the lower-order layer in the output display,
wherein the acquisition unit acquires a similarity degree value between the piece of similarity data and each of a plurality of pieces of lower-order data in the lower-order layer of the piece of similarity data, and
in a case where the user operation is detected, the output processing unit further outputs a display including the region indicating the piece of similarity data positioned at one end and a plurality of regions indicating respective ones of the plurality of pieces of lower-order data positioned on a line extending from the one end in a predetermined shape at respective positions corresponding to the respective similarity degree values of the pieces of lower-order data.

7. A display processing method performed by at least one computer, the method comprising:
acquiring, for each of a plurality of pieces of similarity data extracted by similarity search based on query data, a similarity degree value indicating a similarity with the query data; and
outputting a display including a region indicating the query data positioned at one end and a plurality of regions indicating respective ones of the plurality of pieces of similarity data positioned at respective positions corresponding to the respective similarity degree values of the respective pieces of similarity data on a line which extends from the one end in a predetermined shape.

8. A non-transitory computer readable medium storing a program causing at least one computer to perform a display processing method, the display processing method comprising:
acquiring, for each of a plurality of pieces of similarity data extracted by similarity search based on query data, a similarity degree value indicating a similarity with the query data; and
outputting a display including a region indicating the query data positioned at one end and a plurality of regions indicating respective ones of the plurality of pieces of similarity data positioned at respective positions corresponding to the respective similarity degree values of the respective pieces of similarity data on a line which extends from the one end in a predetermined shape.
